(19) United States
(12) Patent Application Publication
(10) Pub. No.: US 2005/0067366 A1
(43) Pub. Date: Mar. 31, 2005

(54) Plastic closure which can be produced in a closed manner, injection mould and method for the production thereof

(76) Inventor: Werner Fritz Dubach, Maur (CH)

Correspondence Address: PAULEY PETERSEN & ERICKSON, 2800 WEST HIGGINS ROAD, SUITE 365, HOFFMAN ESTATES, IL, 60195, US

(21) Appl. No.: 10/501,178

(22) PCT Filed: Jan. 8, 2003
(86) PCT No.: PCT/CH03/00004

(30) Foreign Application Priority Data
Jan. 11, 2002 (CH) 0043/02

(51) Int. Cl. B65D 43/14; B29C 45/00; B29C 45/03; B29C 45/40

(52) U.S. Cl. 215/235; 425/542; 264/328.1; 264/334; 215/254; 220/837

(57) ABSTRACT

A production of a plastic closure which is essentially a question of cost. Plastic closures with lower parts and covers that are joined to each other by a snap hinge can be manufactured in a particularly advantageous manner if the covers and lower parts are produced in a closed state. According to this invention, the closure is structured so that all the elements of the snap hinge are arranged in the covering wall areas of the closure, which extend in a parallel manner in relation to the direction of movement in which the injection mold is opened and closed. Thus, the cycle times are extremely short and the injection molds can be economically produced.

### BACKGROUND OF THE INVENTION

1. Field of the Invention

This invention relates to a plastic closure including a lower part and a cap and a snap hinge by which the two closure parts are connected to one another as one piece, wherein the lower part and the cap can be manufactured in the closed state and also can be connected to one another via at least one separation seam. This invention also relates to an injection mold for manufacturing the plastic closures and to a method with which the above-mentioned closures may be manufactured using the injection molds according to this invention.

2. Discussion of Related Art

Closures are known for example from Swiss Patent Reference CH-A-673,631. With this a plastic closure with a lower part may be placed on a bottle neck or onto an adapter fastened on the bottle neck. The snap effect of the closure is produced with a spring element which is a bending spring that projects from the container wall from the outside into the inner space of the closure. Thus, the snap effect is not achieved by the deformation of the container walls but solely by the restoring force of the U-shaped spring element.

Openings in the closure walls of the plastic closure are necessary for manufacturing the known plastic closures. On one hand an opening needs to be present in the outer, peripheral lateral wall or skirt in order to shape the U-shaped spring on the inner side, and on an other hand a recess needs to be in the cover surface in order to achieve the upper, outer surface of the U-shaped spring. The manufacture of such a closure thus necessitates relatively large mold slides or sliders which renders the injection molds considerably more expensive and also extends the cycle times. Accordingly, plastic closures of this known type are relatively expensive and up to now could not assert themselves in the marketplace.

Finally, the lack of design freedom is a problem. The manufacturability specifically requires a conical or step-like shaping of the plastic closure, wherein the lateral walls of the cap with respect to the lower part need to be arranged offset to one another at least by the wall thickness.

The same concept as in Swiss Patent Reference CH-A-673,631 has also been taught by Swiss Patent Reference CH-683,611. Here the plastic closure which is injected in the closed state is realized by arranging the lower part and the cap conically on top of one another. Here, in contrast to the first mentioned design there is a snap hinge which is not achieved by a spring element designed as a bending spring, but by two flat intermediate elements through which the tensile forces are transmitted, wherein the spring force is realized solely by the deformation of the adjacent container walls. At the same time, it is necessary for the container walls of the lower part and the cap to run inclined towards the center axis at least in the hinge region. Although such a closure may be manufactured without a slider, it may not be used on conventional bottle necks without an adapter. The necessary conicity results in a diameter difference between the lower part and the sealing peg in the cap which is larger than common bottle necks.

### SUMMARY OF THE INVENTION

It is one object of this invention to provide a plastic closure of the mentioned type which requires only particularly simple injection molds, and which may be manufactured with short cycle times and that permits a cylindrical shaping of the outer contour.

This object is achieved by a plastic closure as described in this specification and in the claims.

Another object of this invention is to manufacture an injection mold for manufacturing plastic closures of the above mentioned type, which are economical to manufacture and which may function with short cycle times.

An injection mold is also described in this specification and in the claims.

This invention also relates to a method for manufacturing the closures of the initially mentioned type while using the previously mentioned injection mold, wherein the method has features and other design forms of this invention are explained in the subsequent description and in the claims.

In one embodiment, the plastic closure according to this invention is represented in the accompanying drawing, whereby a representation of the injection mold and a schematic representation of the method is not shown because the person skilled in the art would not require such a representation on account of the subsequent explanations.

### BRIEF DESCRIPTION OF THE DRAWINGS

One embodiment of a plastic closure according to this invention is shown in the drawings wherein:

FIG. 1 is a lateral view of a plastic closure according to this invention, manufactured in a closed state, placed onto a partly shown container neck;

FIG. 2 shows the same view as FIG. 1 but after removal of a guarantee strip;

FIG. 3 shows again the same plastic closure as shown in FIGS. 1 and 2 but in a diametric vertical section in an opened condition; and

FIG. 4 shows a vertical section taken through the plastic closure according to FIG. 1, before opening for a first time, again shown placed onto a container neck.

### DETAILED DESCRIPTION OF THE INVENTION

The plastic closure manufacturable in the closed state is shown in its entirety as element 1 and comprises a lower part 2 and a cap 3. The lower part 2 and the cap 3 are rotationally symmetrical with regard to the center axis A. The lower part 2 comprises a lateral wall or skirt 5 and the cap 3 comprises a lateral wall or skirt 6. The lower part 2 and the cap 3 are connected to one another as one piece via a snap hinge 4. Furthermore, the lower part 2 and the cap 3 are connected to one another via at least one separation seam 7. At the same time the at least one separation seam 7 always runs from one side of the snap hinge 4 circumferentially about the periphery of the plastic closure 1 to the other side of the snap hinge 4. The separation seam 7 may be formed by a continuous separation line which is only interrupted by several destroyable bridges. In the preferred example shown, continuous thin locations form a so-called tear seam.

The tear seams 8 in particular are clearly shown in FIG. 4, in which the closure is shown in an enlarged scale. Here not a single tear seam 7 is shown but there are two tear seams 7 and 7′ running parallel to one another between which a guarantee strip 9 is present. The guarantee strip 9 at least on one side near or in the vicinity of the snap hinge 4 comprises a tear-open tab 10. In the normal case, the closure is not only rotationally symmetrical with respect to the axis A, but the lateral walls 5, 6 represent sections of the same circular cylinder. The lateral walls 5, 6 are thus situated vertically on top of one another in a completely flush manner. With this shaping the closure may also be used on standard bottle necks. Thus, the container B requires no specially shaped bottle neck F. The cap 3 may have an annular sealing wall 10 which forms a sealing plug 11 that comes to lie directly into the bottle neck F in a sealing manner without an adapter piece. With this not only are the manufacturing costs saved but also the assembly costs.

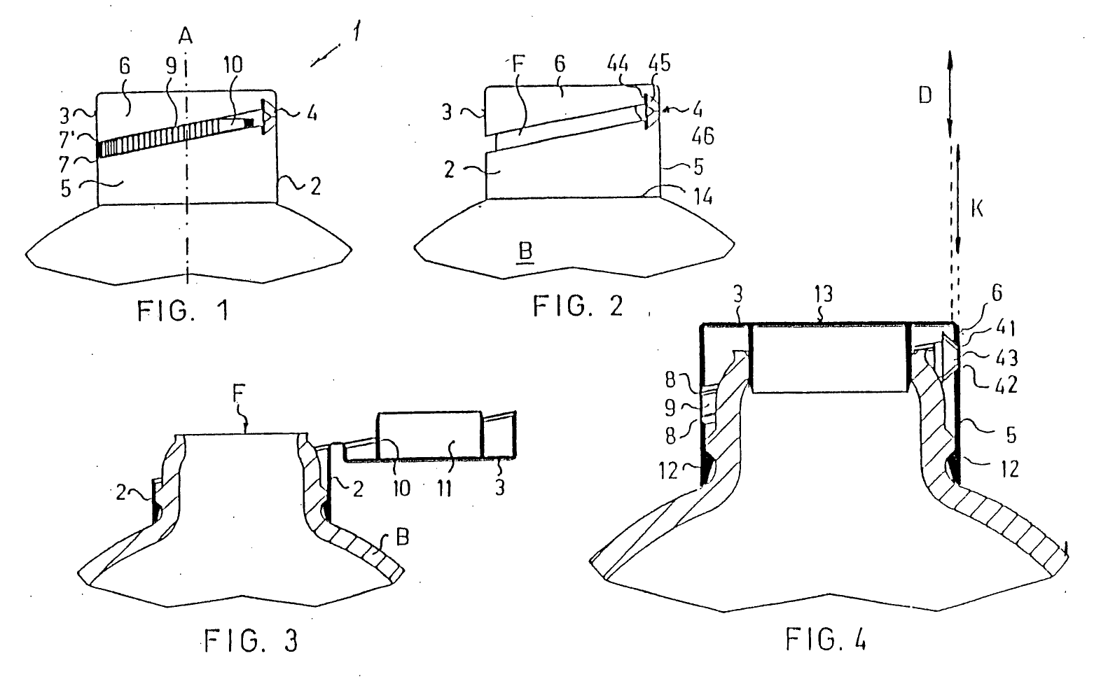

The closure represented here may be pressed onto the container with conventional assembly machines without any problem and with a large cadence. In particular, with the use of continuous tear seam 8, there also exists no danger that the fragile bridges are destroyed near or in the region of the separation seam during assembly. The fastening of the closure 1 on the container neck F is conventional and directly integrally formed on the lateral wall or skirt 5 of the lower part 2. In the example shown, this is an inwardly projecting peripheral retaining bead 12. Instead of the retaining bead 12 retaining bead sections can be provided. In particular, in FIGS. 1 and 4, the lateral walls of the upper part and the lower part in the embodiment shown are completely smooth on the outer surface. In contrast to this, the inner surfaces of the lateral walls of the upper part and lower part comprise inward formations and outward formations. Inward formations and outward formations are understood as changes in the wall thickness, wherein recesses in the lateral wall or skirt surface are indicated as inward formations which are considered here while outward formations are considered as protuberances with respect to the lateral wall or skirt surface.

In the example shown here, all inward formations and outward formations are arranged on the inner surface of the lateral walls of the lower part and lid. This is one sensible design but it is also possible to incorporate all inward formations and outward formations on the outer surfaces of the lower part and the lid. For achieving the object according to this invention, it is necessary for the snap hinge to lie in the lateral wall or skirt regions of the closure which run parallel to the closure and opening movement direction of the injection mold. An injection mold in the simplest case includes two tool halves. These tools are mostly also called plates. While the one tool half comprises cavities which form the outer surfaces of the closure manufactured therein, the other tool half comprises so-called mandrels which when traversing together the two tool halves enter the cavities of the other tool half. The remaining cavity is filled with plastic and forms the plastic closure to be produced. While no shape deviations from this movement direction were believed allowable, on the lateral walls which run parallel to the opening and closure movement without suitable sliders or other moving parts provided on the injection mold, now one has moved away from this belief.

In particular, threads on closures or retaining beads are now permissible. It is essential that the two injection mold parts are traversed apart, so that the material may escape at least on one side, in order to completely remove the respective injection mold object from the mold. The plastic closure according to this invention was conceived in its design on the basis of this principle. In particular, with snap hinge closures, this manufacturing concept until now has not been used for producing the snap hinge. Particularly aesthetic closures result from this concept if the lateral walls of the lower part 2 and the cap 3 at least in the region of the snap hinge are arranged lying in a flush manner on top of one another. With this, the region is understood as a cylinder sector, and the regions of the snap hinge up to the cover surface 13 of the lid, and from the snap hinge 4 to the lower edge 14 of the lower part 2 lie on top of one another in a completely flush manner. The adjacent wall regions may be designed to run in an inclined manner. This however is not desirable in many cases. Accordingly, one would preferably arrange the lateral walls 5, 6 lying on top of one another in a completely flush manner.

As mentioned, only the inner surfaces or only the outer surfaces should have inward formations and/or outward formations. The inward formations and/or outward formations may at the same time not exceed the wall thickness of the lateral walls. This is understood as within the framework of the usual accuracies and tolerances. The larger the total diameter of the closure, the larger the possible relative deviation. This is known to the person skilled in the art of plastics technology, and does not have to be explained any further.

One has freedom with regard to the shaping of the guarantee strip. However, the guarantee strip 9 and the tab 10 form part regions of the lateral walls 5, 6 which lie on top of one another. The closure may only be opened by tearing away the guarantee strip 9. As mentioned, and represented in the drawing, the separation seams 7, 7′ which delimit the guarantee strip run parallel to one another. If both separation seams run parallel to one another then they may run perpendicular or inclined relative to the center axis or to the central middle axis A of the closure. Of course the separation seams 7, 7′ may also be arranged in planes running differently to the central middle axis A, wherein in the special case the one separation seam may run perpendicularly to the central middle axis and the second separation seam 7 may run inclined to the central middle axis A.

The snap hinge corresponds essentially to a snap hinge as known from European Patent Reference EP-A-0'056'469 or from U.S. Pat. No. 3,135,456. These are snap hinges which are formed essentially of two film hinges. The one film hinge 41 represents the movable connection between the lateral wall or skirt 6 of the cap 3 and an intermediate element 43, the second film hinge 42 forms the separation line between the lateral wall or skirt 5 of the lower part 2 and the intermediate element 43 of the snap hinge 4. The snap hinge has lateral limitations 44 which are formed by a gap. The film hinges 41, 42 between the two lateral limitations 44 may have various running directions. Thus, the previously mentioned documents are incorporated by reference. Basically, the film hinges 41, 42 may centrally approach one another or run part between the two limitations 44. Furthermore, the film hinges may have an arcuate shape, or one which is sharply bent, and they may approach one another to such an extent that they mutually contact, by which two lateral intermediate elements 45 transmitting tensile forces arise. As mentioned, the lateral limitations 44 are separated from the lateral walls 5, 6 by a gap. This gap 46 thus forms the separation between the intermediate element or the intermediate elements or between the elements and the adjacent lateral walls 5, 6. However, the lateral limitations 44 may however also be connected to the adjacent lateral walls practically as an additional guarantee element, wherein the connections need to be designed as separation seams. When opening the closure for the first time, these separation seams would tear.

As mentioned, the plastic closures according to this invention may be manufactured by injection molds, wherein an injection mold includes two plates of which the one plate comprises the cores and the other plate the cavities. At the same time, at least one of the two plates has no recesses or protuberances on the surfaces parallel to the extension direction of the plate. Accordingly, plastic closures which are manufactured by these injection molds have no inward formations or outward formations on the corresponding lateral wall or skirt surfaces. For the manufacture of the closures as are represented in the FIGS. 1 to 4, the plate with the mandrels with the surfaces parallel to the extension direction have protuberances and/or recesses which form the corresponding outward formations and/or inward formations, while the cavities on the other plate on the surfaces lying parallel to the extension direction have no recesses or protuberances. A corresponding reversion is likewise possible.

If one operates with the described injection molds in order to shape the corresponding closures, it is necessary to extend that plate which has no recesses or protuberances on the surfaces running parallel to the extension direction. If then the closures are set free on one side, then they may be ejected under suitable elastic deformation from the other plate on which corresponding recesses or protuberances are parallel to the extension and retraction direction of the molds. Usually, with this, as already mentioned, one would shape the cavities free of recesses and protuberances. Accordingly, first the plate comprising the cavities is retracted and after this the cores are pulled from the closures. Again, a reversion is also possible. If the closures have smooth inner surfaces of the lateral walls, one may then first pull the cores from the closures and of course after this eject the closures from the cavities.

1. A plastic closure comprising: a lower part, a cap and a snap hinge connecting the lower part and the cap to one another as one piece, the lower part and the cap manufacturable in a closed state and connected to one another by at least one separation seam, and all elements of the snap hinge positioned in a lateral wall region of the closure which run parallel to a closing and opening movement direction of an injection mold.

2. A plastic closure according to claim 1, wherein the lateral walls of the lower part and the cap are arranged on top of one another in a flush manner at least in a region of the snap hinge.

3. A plastic closure according to claim 1, wherein the lateral walls of the lower part and the cap lie on top of one another in a completely flush manner.

4. A plastic closure according to claim 3, wherein the lateral walls of the lower part and the cap on an outer surface are free of one of inward formations and outward formations, and inner surfaces comprise at least one of inward formations and outward formations not exceeding a wall thickness of the lateral walls.

5. A plastic closure according to claim 3, wherein the lateral walls of the lower part and the cap on the inner surface are free of one of inward formations and outward formations, and the outer surfaces have at least one of inward formations and outward formations not exceeding a wall thickness of the lateral walls.

6. A plastic closure according to claim 1, wherein the lower part and the cap are connected to one another by two separation seams which delimit a guarantee strip, and the two separation seams proceeding from a lateral limitation of the snap hinge are positioned around the closure up to at least approximately an other lateral limitation of the snap hinge.

7. A plastic closure according to claim 6, wherein the two separation seams run parallel to one another.

8. A plastic closure according to claim 6, wherein the two separation seams run in two planes perpendicular to a central middle axis of the closure.

9. A plastic closure according to claim 6, wherein the two separation seams run in planes inclined to a central middle axis of the closure.

10. A plastic closure according to claim 6, wherein the two separation seams run in planes which are differently inclined with respect to a central middle axis of the closure.

11. A plastic closure according to claim 1, wherein the snap hinge is formed of two film hinges which from one lateral limitation to an other limitation of the snap hinge follow a course that one of centrally approach one another and diverge from one another.

12. A plastic closure according to claim 11, in that wherein the two film hinges at a middle portion contact one another at least approximately and follow one of a curved course and a sharp bend, wherein Hey the film hinges laterally enclose two lateral intermediate elements transmitting tensile forces.

13. A plastic closure according to claim 11, wherein the lateral limitations of intermediate elements are separated from the lateral walls by a gap.

14. A plastic closure according to claim 11, wherein the lateral limitations of intermediate elements are connected to the adjacent lateral walls by separation seams that tear on opening for a first time.

15. A plastic closure according to claim 14, wherein an injection mold for manufacturing the plastic closure has two plates, one of the plates has cores and an other of the plates has cavities, and at least one of the plates on surfaces parallel to an extension direction of the plates is free of one of recesses and protuberances.

16. An injection mold according to claim 15, wherein mandrels on the one plate in the surfaces parallel to the extension direction comprise at least one of protuberances and recesses, and the other plate with the cavities on surfaces parallel to the extension direction is free of one of recesses and protuberances.

17. An injection mold according to claim 15, wherein the cavities in the surfaces parallel to the extension direction are one of recesses and protuberances, and the surfaces of mandrels parallel to the extension direction are free of one of protuberances and recesses.

18. A plastic closure according to claim 17, wherein a method for manufacturing the plastic closure comprises first extending the plates with one of the mandrels and the cavities with surfaces parallel to the extension direction which are free of one of the recesses and the protuberances and then ejecting the plastic closures which are free at one side from the other plate.

19. A method according to claim 18, wherein first the other plate with the cavities is retracted and then cores are pulled from the plastic closures.

20. A method according to claim 18, wherein first cores are pulled from the plastic closures and then the plastic closures are ejected.

21. A plastic closure according to claim 15, wherein a method for manufacturing the plastic closure comprises first extending the plates with one of mandrels and the cavities with surfaces parallel to the extension direction which are free of one of the recesses and the protuberances, and then ejecting the plastic closures which are free at one side from the other plate.

22. A method according to claim 21, wherein first the other plate with the cavities is retracted and then cores are pulled from the plastic closures.

23. A method according to claim 21, wherein first cores are pulled from the plastic closures and then the plastic closures are ejected.

24. A plastic closure according to claim 1, wherein an injection mold for manufacturing the plastic closure has two plates, one of the plates has cores and an other of the plates has cavities, and at least one of the plates on surfaces parallel to an extension direction of the plates is free of one of recesses and protuberances.

25. An injection mold according to claim 24, wherein mandrels on the one plate in the surfaces parallel to the extension direction comprise at least one of protuberances and recesses, and the other plate with the cavities on surfaces parallel to the extension direction is free of one of recesses and protuberances.

26. An injection mold according to claim 24, wherein the cavities in the surfaces parallel to the extension direction are one of recesses and protuberances, and the surfaces of mandrels parallel to the extension direction are free of one of protuberances and recesses.
